(19) United States
(12) Patent Application Publication
(10) Pub. No.: US 2015/0063780 A1
(43) Pub. Date: Mar. 5, 2015

(54) Providing Audible Indication During Content Manipulation

(71) Applicant: Sony Corporation, Tokyo (JP)

(72) Inventor: Peter Shintani, San Diego, CA (US)

(73) Assignee: Sony Corporation, Tokyo (JP)

(21) Appl. No.: 14/015,019

(22) Filed: Aug. 30, 2013

(51) Int. Cl. G11B 27/34; G11B 27/30; H04N 9/87

(52) U.S. Cl. CPC G11B 27/34; H04N 9/87; G11B 27/30
USPC 386/241

(57) ABSTRACT

An apparatus includes at least one computer readable storage medium that is not a carrier wave and that is accessible to a processor. The computer readable storage medium bears instructions which when executed by the processor cause the processor to present, on an audio video display device (AVDD), an audible indication of a position of a currently displayed video portion of audio video content within the audio video content.

### I. FIELD OF THE INVENTION

The present application relates generally to providing assistance to the visually impaired when manipulating content on a consumer electronics (CE) device.

### II. BACKGROUND OF THE INVENTION

While the visually impaired are often capable of manipulating consumer electronics (CE) devices presenting, e.g., audio video (AV) content thereon such by fast forwarding or rewinding the content, at times it may prove difficult to determine where to resume normal playback of the content owing to combination of the speed at which the content's images are presented when fast-forwarded or rewound and the person's visual impairment. Indeed, efficiency and ease of content manipulation may often prove difficult for a visually impaired person under such circumstances given need to quickly recognize a desired position within the content at which to resume playback and then, e.g., select a play button on a remote control to resume normal playback at the desired position. Present principles therefore recognize a need to provide a solution to assist the visually impaired to manipulate content presented on a CE device that does not necessarily involve the use of, e.g., a specialized supplemental device used in conjunction with the CE device and adapted specifically for use by the visually impaired.

### SUMMARY OF THE INVENTION

Accordingly, in one embodiment an apparatus includes at least one computer readable storage medium that is not a carrier wave and that is accessible to a processor. The computer readable storage medium bears instructions which when executed by the processor cause the processor to present, on an audio video display device (AVDD), an audible indication of a position of a currently displayed video portion of audio video content within the audio video content.

In some embodiments, the audible indication may be derived from metadata associated with the audio video content. Also in some embodiments, the audible indication may be expressed in temporal parameters related to the currently displayed video portion such as e.g. minutes and seconds. However, in addition to or in lieu of the audible indication being expressed in such temporal parameters, the audible indication may include presenting a segment of audio from the audio video content and/or may include a description of the audio video content derived from metadata of the audio video content.

Whatever the configuration of the audible indication, present principles nonetheless recognize that in some exemplary embodiments, the audible indication may be presented at least in part in response to user manipulation of the audio video content that alters normal playback of the audio video content, where the user manipulation may be e.g. fast-forwarding or rewinding. Furthermore, the audible indication may be presented only when a visually impaired setting of the AVDD is set to active in some embodiments. Further still, if desired a visual indication of the position may be presented along with the audible indication. The visual indication may be e.g. displayed in typography adapted for the visually impaired.

In another aspect, a method includes receiving, at a consumer electronics (CE) device, audio video (AV) content and also receiving, at the CE device, AV content position information associated with the temporal position within the AV content of at least one segment of video of the AV content. The method then includes presenting, on the CE device, at least the segment of video of the AV content and then presenting, on the CE device at or around the time the segment of the AV content is presented, at least a portion of the AV content position information indicating the temporal position of the segment within the AV content.

In still another aspect, a computer readable storage medium bears instructions which when executed by a processor configure the processor to execute logic including embedding AV content metadata associated with audio video (AV) content in an AV content file, where the AV content metadata includes temporal position information for at least one segment of the AV content. The logic also includes providing the AV content file to at least one consumer electronics (CE) device.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an exemplary system including a CE device in accordance with present principles;

FIG. 2 is an exemplary flowchart of logic to be executed by a CE device to audibly present position information regarding the current position of AV content being manipulated in accordance with present principles;

FIG. 3 is an exemplary flowchart of logic to be executed by a server for providing position information for AV content along with the AV content to one or more CE devices in accordance with present principles;

FIGS. 4-6 are exemplary screen shots of visually presenting position information on a CE device in accordance with present principles; and

FIG. 7 is an exemplary settings UI for a CE device that includes at least one visually impaired setting that is configurable by a user of the CE device.

### DETAILED DESCRIPTION OF THE PREFERRED EMBODIMENT

Disclosed are methods, apparatus, and systems for consumer electronics (CE) device based user information. A system herein may include server and client components, connected over a network such that data may be exchanged between the client and server components. The client components may include one or more computing devices. These may include televisions (e.g. smart TVs, Internet-enabled TVs, and/or high definition (HD) TVs), personal computers, laptops, tablet computers, and other mobile devices including smart phones. These client devices may operate with a variety of operating environments. For example, some of the client computers may be running Microsoft Windows® operating system. Other client devices may be running one or more derivatives of the Unix operating system, or operating systems produced by Apple® Computer, such as the IOS® operating system, or the Android® operating system, produced by Google®. While examples of client device configurations are provided, these are only examples and are not meant to be limiting. These operating environments may also include one or more browsing programs, such as Microsoft Internet Explorer®, Firefox, Google Chrome®, or one of the other many browser programs. The browsing programs on the client devices may be used to access web applications hosted by the server components discussed below.

Server components may include one or more computer servers executing instructions that configure the servers to receive and transmit data over the network. For example, in some implementations, the client and server components may be connected over the Internet. In other implementations, the client and server components may be connected over a local intranet, such as an intranet within a school or a school district. In other implementations a virtual private network may be implemented between the client components and the server components. This virtual private network may then also be implemented over the Internet or an intranet.

The data produced by the servers may be received by the client devices discussed above. The client devices may also generate network data that is received by the servers. The server components may also include load balancers, firewalls, caches, and proxies, and other network infrastructure known in the art for implementing a reliable and secure web site infrastructure. One or more server components may form an apparatus that implement methods of providing a secure community to one or more members. The methods may be implemented by software instructions executing on processors included in the server components. These methods may utilize one or more of the user interface examples provided below.

The technology is operational with numerous other general purpose or special purpose computing system environments or configurations. Examples of well-known computing systems, environments, and/or configurations that may be suitable for use with the invention include, but are not limited to, TVs, personal computers, server computers, hand-held or laptop devices, multiprocessor systems, processor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor such as the AMD® Athlon® II or Phenom® II processor, Intel® i3®/i5®/i7® processors, Intel Xeon® processor, or any implementation of an ARM® processor. In addition, the processor may be any conventional special purpose processor, including OMAP processors, Qualcomm® processors such as Snapdragon®, or a digital signal processor or a graphics processor. The processor typically has conventional address lines, conventional data lines, and one or more conventional control lines.

The system is comprised of various modules as discussed in detail. As can be appreciated, each of the modules comprises various sub-routines, procedures, definitional statements and macros. The description of each of the software/logic/modules is used for convenience to describe the functionality of the preferred system. Thus, the processes that are undergone by each of the software/logic/modules may be arbitrarily redistributed to one of the other software/logic/modules, combined together in a single software process/logic flow/module, or made available in, for example, a shareable dynamic link library.

The system may be written in any conventional programming language such as C#, C, C++, BASIC, Pascal, or Java, and run under a conventional operating system. C#, C, C++, BASIC, Pascal, Java, and FORTRAN are industry standard programming languages for which many commercial compilers can be used to create executable code. The system may also be written using interpreted languages such as Pert Python or Ruby. These are examples only and not intended to be limiting.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a, computer-readable storage medium. Computer-readable media include both computer storage media and communication media including any medium that facilitates transfer of a computer program from one place to another. However, a computer readable storage medium is not a carrier wave, and may be any available media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Also, any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as may be used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The foregoing description details certain embodiments of the systems, devices, and methods disclosed herein. It will be appreciated, however, that no matter how detailed the foregoing appears in text, the systems, devices, and methods can be practiced in many ways. As is also stated herein, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” While various aspects and embodiments have been disclosed herein, other aspects and embodiments may be apparent. The various aspects and embodiments disclosed herein are for purposes of illustration and are not intended to be limiting.

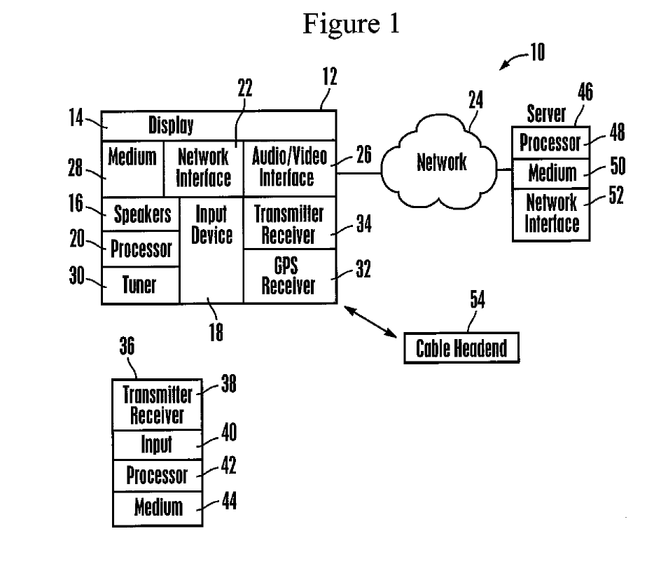

Referring now to FIG. 1, an exemplary system 10 includes at least one consumer electronics (CE) device 12 that in exemplary embodiments is a television (TV) such as e.g. a high definition TV and/or Internet-enabled smart TV. However, present principles recognize that the CE device 12 may also be e.g. a wireless and/or mobile telephone, smart phone (e.g., an Internet-enabled and touch-enabled mobile telephone), a laptop computer, a desktop computer, a tablet computer, a PDA, a video game console, a video player, a personal video recorder, a smart watch, a music player, etc. Regardless, it is to be understood that the CE device 12 is configured to undertake present principles (e.g. to present audible indications of various positions within AV content of currently presented segments).

Describing the CE device 12 with more specificity, it includes a touch-enabled display 14, one or more speakers 16 for outputting audio such as audio including the audible indications described herein in addition to audio of AV content, and at least one additional input device 18 such as, e.g., an audio receiver/microphone, keypad, touchpad, etc. for providing input and/or commands (e.g. audible commands) to a processor 20 for controlling the CE device 12 in accordance with present principles. The CE device 12 also includes a network interface 22 for communication over at least one network 24 such as the Internet, an WAN, a LAN, etc. under control of the processor 20, it being understood that the processor 20 controls the CE device 12 including presentation of emergency information as disclosed herein. Furthermore, the network interface 22 may be, e.g., a wired or wireless modem or router, or other appropriate interface such as, e.g., a wireless telephony transceiver.

In addition to the foregoing, the CE device 12 may include an audio video interface 26 such as, e.g., a USB or HDMI port for receiving input (e.g. AV content) from a component device such as e.g. a set top box or Blue Ray disc player for presentation of the content on the CE device 12, as well as a tangible computer readable storage medium 28 such as disk-based or solid state storage. The medium 28 is understood to store the software code and/or logic discussed herein for execution by the processor 20 in accordance with present principles. Further still, the CE device 12 may also include a TV tuner 30 and a GPS receiver 32 that is configured to receive geographic position information from at least one satellite and provide the information to the processor 20, though it is to be understood that another suitable position receiver other than a GPS receiver may be used in accordance with present principles.

Moreover, it is to be understood that the CE device 12 also includes a transmitter/receiver 34 for communicating with a remote commander (RC) 36 associated with the CE device 12 and configured to provide input (e.g., commands) to the CE device 12 (e.g. to the processor 20) to thus control the CE device 12. Accordingly, the RC 36 also has a transmitter/receiver 38 for communicating with the CE device 12 through the transmitter/receiver 34. The RC 36 also includes an input device 40 such as a keypad or touch screen display, as well as a processor 42 for controlling the RC 36 and a tangible computer readable storage medium 44 such as disk-based or solid state storage. Though not shown, in some embodiments the RC 36 may also include a touch-enabled display screen and a microphone that may be used for providing input/commands to the CE device 12 in accordance with present principles.

Still in reference to FIG. 1, reference is now made to a server 46 of the system 10. The server 46 includes at least one processor 48, at least one tangible computer readable storage medium 50 such as disk-based or solid state storage, and at least one network interface 52 that, under control of the processor 48, allows for communication with the CE device 12 (and even a cable head end 54 to be described shortly) over the network 24 and indeed the server 46 may facilitate communication between the CE device 12, server 46, and/or cable head end 54. Note that the network interface 52 may be, e.g., a wired or wireless modem or router, or other appropriate interface such as, e.g., a wireless telephony transceiver. Accordingly, in some embodiments the server 46 may be an Internet server, may facilitate the transmission of AV content and content position information as disclosed herein to the CE device 12, and may include and perform “cloud” functions such that the CE device 12 may access a “cloud” environment via the server 46 in exemplary embodiments. Additionally, note that the processors 20, 42, and 48 are configured to execute logic and/or software code as disclosed herein.

Describing the head end 54 mentioned above, it is to be understood that although the head end 54 is labeled as a cable head end in particular in FIG. 1, it may be a satellite head end as well. The head end 54 is understood to be in communication with the CE device 12 and/or server 46 over, e.g., a closed network (through a wired or wireless connection), and furthermore may itself include a network interface (not shown) such that the head end 54 may communicate with the CE device 12 and/or server 46 over a wide-area and/or open network such as the network 24. Further still, it is to be understood that the head end 54 may be wired or wirelessly connected to a non-internet server, and/or may optionally be integrated with a non-internet server. In any case, it is to be understood that the head end 54 may facilitate the transmission of AV content, AV content files, and AV content position information to the CE device 12 in accordance with present principles and may even, e.g. multiplex the AV content position information with the AV content to thereby provide both to a CE device in e.g. a stream.

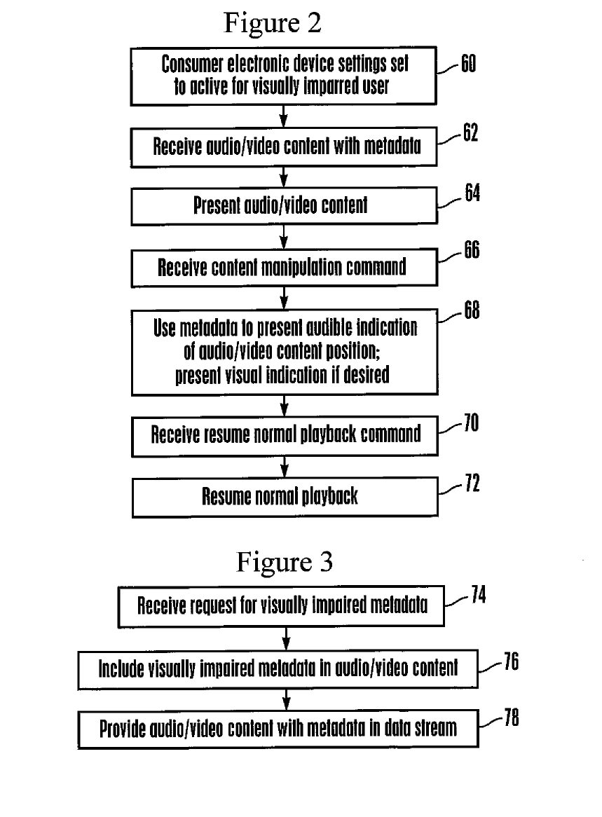

Turning now to FIG. 2, an exemplary flowchart of logic to be executed by a CE device such as the CE device 12 to present at least one audible indication of a position of a currently presented segment of video within AV content in accordance with present principles is shown. Beginning at block 60, the logic sets at least one CE device setting to active for a visually impaired user (e.g. based on at least one visually impaired setting being configured prior). Such visually impaired settings may in some embodiments involve e.g. presenting closed captioning in relatively larger text than a normal presentation setting, and/or amplifying volume, but in any case configuration of such settings may be used to assist the visually impaired in accordance with the currently described position indication principles.

For example, automatically without user input the logic may determine that position information may be presented audibly and/or visually as described herein based on previous configuration of one or more of the above settings rather than configuration of a setting specifically pertaining to whether to present audible and visual position indications. Nonetheless, in some exemplary embodiments an AV content position indication setting in particular may be included in addition to or in lieu of the settings discussed above to thus configure a CE device to undertake present principles. Further still, in addition to or in lieu of the foregoing, a “universal” visually impaired setting may be configured by a user which in turn automatically without further user input may configure one or more (e.g. all) other CE device settings pertaining to visually impaired-related (and/or designated) settings to active, such as those settings described above, to further assist with the presentation of content (e.g. AV content and position information/indications) to the visually impaired.

In any case, after block 60 the logic proceeds to block 62 where the logic receives AV content and metadata associated therewith, where the metadata includes position information for one or more segments of the AV content. The different pieces of position information may thus be configured for presentation (e.g. audible and/or visual) at respective times when the segment to which the piece pertains is presented on the CE device executing the logic of FIG. 2 either or both audibly and visually. This AV content and metadata may have been provided by e.g., a server and/or head end, such as the server 46 and head end 54 described above. Either way, after the AV content and position information metadata is received at block 62, the logic moves to block 64 where the AV content is presented on the CE device.

Thereafter, at block 66, the logic receives a content manipulation command from a user to alter normal playback of the AV content such as e.g. a fast forward command, a rewind command, a pause command, and/or a slow-motion command. The logic then proceeds to block 68 where the logic uses the metadata received at block 62 to present an (e.g. audible and/or visual) indication on the CE device of the current (e.g. temporal) position within the AV content as whole of a currently presented segment of the AV content (e.g. the segment being currently presented when the audible indication is presented). After block 68, the logic moves to block 70 where the logic receives a command (e.g. from a user) to resume normal playback of the AV content (e.g., to stop fast forwarding or rewinding by selecting a play button on a RC). The logic then resumes normal playback of the AV content at block 72.

Now in reference to FIG. 3, it shows an exemplary flowchart of logic to be executed by a server and/or a head end (such as e.g. the server 46 or cable head end 54) for providing AV content and position information corresponding in particular to at least one segment of the AV content to one or more CE devices such as the CE device 12. The logic begins at block 74 where the logic receives a request (e.g. from a CE device over a network e.g. as requested by a user of the CE device by manipulating the CE device) that metadata (e.g. for the visually impaired) be included in AV content to be provided (e.g. also based on the request) to the CE device, such as information and/or indications pertaining to one or more (e.g. different) positions of segments of AV content. After receiving the request, the logic moves to block 76 where the logic includes (e.g., by embedding) such metadata in an AV content file also including the AV content that is to be provided to the CE device. The logic thereafter provides the file e.g. in a data stream to one or more CE devices at block 78.

Note that the metadata included in the file provided to the CE device may include temporal position information for at least one segment of the AV content that is presentable (e.g. automatically) when that segment of AV content is presented on the CE device in accordance with present principles, and thus the metadata may be configured at least for causing audible presentation of such temporal position information included in the metadata and optionally also visual presentation (e.g. based on user configuration of a visually impaired setting of the CE device) of such temporal position information. Furthermore, the temporal position information provided to a CE device as described in reference to FIG. 3 may include e.g. temporal data that is related to the particular segment expressed in minutes and seconds, may include audio snippets extracted from audio related to the particular segment, and/or may include an audio description and/or summary of the particular segment that does not include audio extracted from the AV content itself but instead e.g. is separate audio/visual information spoken by a narrator that does not constitute part of the audio of the AV content itself and/or that is indicated textually by such a narrator.

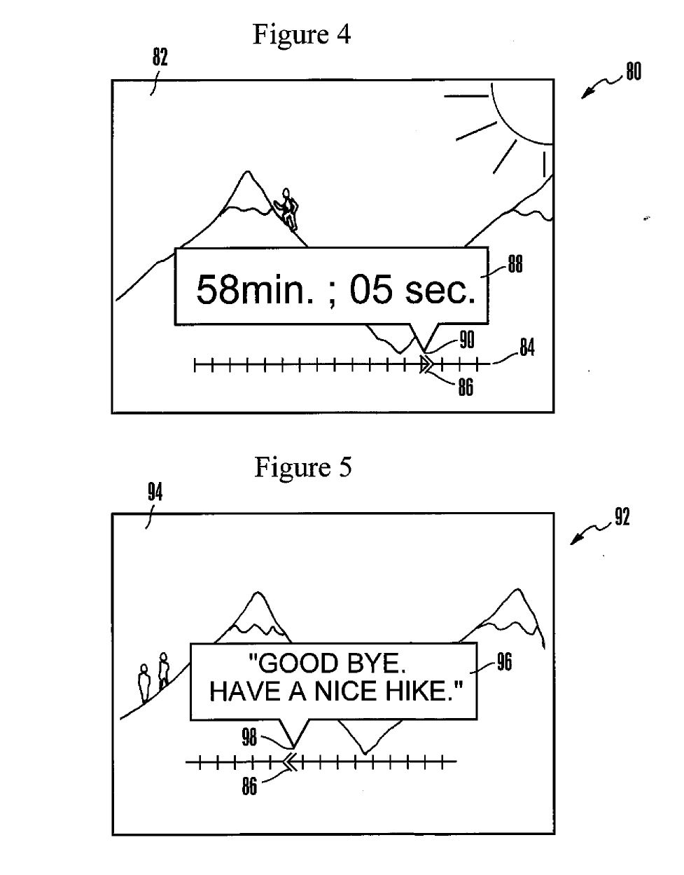

Continuing the detailed description in reference to FIGS. 4-6, screen shots are shown of exemplary position information presentable on a CE device and associated with a segment of the AV content currently as shown on the respective screen shots of these figures in accordance with present principles. As may be appreciated jointly from FIGS. 4-6, the exemplary AV content of the screen shots pertains to a hiking trip up and down mountains, though it is to be understood that the AV content is for exemplary purposes only and indeed any AV content may be presented in accordance with present principles. Distinguishing FIGS. 4-6 and as may be appreciated further from the description below, the screen shots show different segments of the AV content presented at different times as reflected by their respective screen shots (e.g. each being “currently presented” in that it is presented at the time of the respective screen shot).

Regardless, reference is now specifically made to FIG. 4, which shows a screen shot 80 of a (e.g. at least video) segment 82 of the AV content referenced above, where a hiker is descending a left-most mountain. As may be appreciated from the screen shot 80, a user-manipulable progress bar 84 is shown, the length of which represents the temporal length of the AV content (e.g. in totality). The progress bar 84 also includes an indicator 86 configured as shown as double right arrows in FIG. 4.

The indicator 86 as described in reference to each of FIGS. 4-6 is understood to indicate the temporal position within the AV content of the currently presented segment 82 (represented by its location on the progress bar 84), it being understood in exemplary embodiments and as indicated above that the entirety of the progress bar 84 e.g. from left to right represents the AV content in totality from start (e.g. the left-most portion) to finish (e.g. the right most portion). It is to be further understood that the progress bar 84 and/or indicator 86 are manipulable based on e.g. touch input, RC controls, etc. to adjust the position of the indicator 86 on the bar 84 and hence cause a segment of the AV content to be presented at a temporal position represented by a location on the progress bar 84 to which the indicator 86 is moved based on user input. Thus, in exemplary embodiments the user input may be directed to the indicator 86 in particular, and/or another portion of the bar 84 to which it is desired that the indicator 86 be automatically moved, and the AV content presentation is thus adjusted according to where the indicator 86 is moved. Further still, note that the double arrows of the indicator 86 as shown in FIG. 4 is understood to denote that fast forwarding the AV content is being executed at the current time the CE device is presenting the segment as shown on the screen shot 80. However, note that the indicator 86 may appear as a single right arrow when normal playback is executed to thus represent normal playback.

Regardless, it is to be understood that the screen shot 80 of the segment 82 (e.g. a portion, frame of video, and/or frames of video) shows a temporal moment and/or particular segment (e.g. of video) of AV content that is being fast-forwarded through, but that the segment 82 may no longer presented as the CE device continues to change presentation of the AV content by continuing to execute fast forwarding to then display another segment and even another segment after that as fast forwarding continues. Accordingly, to assist a visually impaired user in accordance with present principles, a visual indication 88 may be presented on the screen shot 80 that is configured e.g. as a caption dialogue box (e.g. reminiscent of a cartoon caption box) with a lower portion progressively tapering down to a point 90 at or immediately above the indicator 86 to thereby indicate that what is presented in an upper portion of the visual indication 88 represents information associated temporally with the currently presented segment and thus the position of the indicator 86 on the bar 84 as visually presented at the time of the screen shot 80.

In the present instance shown, the information contained in the indication 88 indicates in relatively large text (e.g., a typography adapted for the visually impaired for legibility by a visually impaired user, where furthermore the typography may be configured in some embodiments e.g. in higher contrast relative to other text or a background of the segment 82 and/or visual indication 88, in a large type size and/or weight, and/or with large spacing for both textual letters and lines of text to make them distinguishable to the visually impaired) that the segment 82 is a segment (e.g. of video) of the AV content that is fifty eight minutes and five seconds into (e.g. what would otherwise be normal, continuous real-time presentation of) the AV content (e.g. from the beginning of the AV content).

It may now be appreciated that presenting this temporal information in e.g. a typography adapted for the visually impaired aids a visually impaired user with effectively and efficiently manipulating the AV content by providing means for discerning precisely (or at least substantially) where in the totality of the AV content the presented segment 82 is located to aid a user when e.g. fast-forwarding to a desired segment or portion.

Furthermore, it is to be understood that the information contained in the indication 88 may also be audibly rendered on the CE device in accordance with present principles at the same time or around the same time that the indication 88 is presented, and hence a (e.g. artificial intelligence (AI)) voice, and/or prerecorded audio, etc., may be used to audibly present the temporal information to a user that is reflected in the indication 88. In the present instance, for example, an audible indication of the position information may include audibly indicating the following (e.g. using an AI voice): “Fifty eight minutes, five seconds,” “Location is fifty eight minutes, five seconds,” or “Fast forwarding at fifty eight minutes, five seconds.” What's more, it is to be understood that similar principles regarding the audible and visual indications may be applied when performing other types of manipulation of the AV content (e.g. altering normal playback) such as rewinding, as described in reference to FIG. 5.

FIG. 5 thus shows a screen shot 92 of a segment 94 of the AV content referenced above. As may be appreciated by the segment 94 shown on the screen shot 92, a hiker is about to ascend a left-most mountain. Also, as may be appreciated from the current location of the indicator 86 on the bar 84 to the left of where the indicator 86 was positioned in FIG. 4, the segment 94 is understood to be a segment of the AV content e.g. at a temporal position within the AV content before the segment 82. Note the change in configuration and/or presentation of the indicator 86 such that it is configured for visual presentation as double left arrows (rather than double right arrows as shown in FIG. 4) to indicate that a rewind of the AV content is currently being executed (e.g. the double left arrows indicate rewinding and double right arrows indicate fast forwarding).

In further contrast to FIG. 4, rather than presenting position information for a segment of AV content in temporal parameters such as hours, minutes, and seconds, a (e.g. dialog box) visual indication 96 that tapers to a point 98 similar to the indication 88 as described above instead visually presents position information by presenting at least a portion of the audio itself from the audio video content as text by converting the audio to text (e.g. using speech to text conversion software) and presenting it thereon. Furthermore, an audible indication that includes at least a portion of the audio from the AV content may similarly be audibly presented save the need for any conversion to text for presentation on the CE device. In this respect, a portion of audio from the AV content can be selected (e.g. extracted) from the AV content and provided audibly on the CE device. Put another way, various portions of audio from the AV content can be extracted as audio snippets that can be “blurted out” as manipulation of the content such as fast forwarding or rewinding occurs and continues to thereby provide ongoing indications of the position of the segment within the AV content being presented at any given time during e.g. rewind or fast forward to thus provide a visually impaired user with a frame of reference of where in the AV content to which the content has currently been manipulated.

Accordingly, as may be appreciated from FIG. 5, audio from the AV content that is to be included in an audible indication for presentation on the CE device during rewinding (and that thus indicates position information of the segment 94 when the segment 94 (e.g. a video frame) is presented during rewinding) includes the following exemplary audio from the AV content itself: “Good bye. Have a nice hike.” Moreover, by using e.g. speech to text software, this audio from the AV content (or audio from another segment close to it) may be converted to text for presentation of text thereby reflecting the audio as a visual indication 98. The indication 98 may be presented in e.g. typography for the visually impaired as described herein. This provides yet another means for conveying to a visually impaired user a currently presented segment of AV content being manipulated.

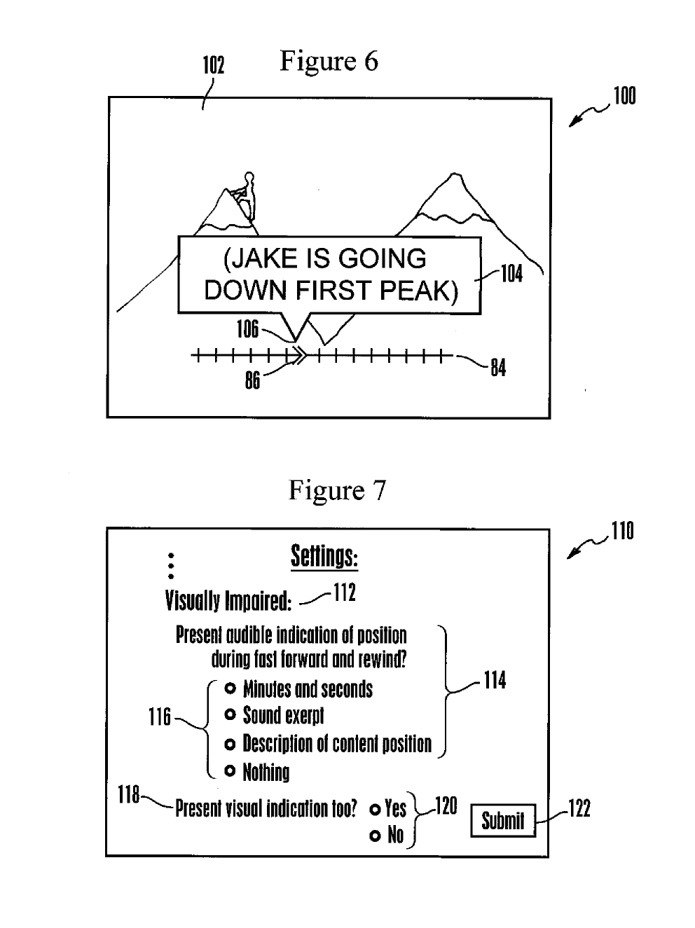

Yet another exemplary screen shot 100 of a segment 102 (e.g. a frame of video) of AV content is shown in FIG. 6. The segment 102 is understood to show yet another portion of the AV content at another (e.g. temporal) position within the AV content. Furthermore, it is to be understood that the segment 102 (and indeed the segments 82 and 94) have position metadata and/or position information associated therewith for presentation of audible and visual indications as disclosed herein to a user.

As may be appreciated from FIG. 6, the indicator 86 is again shown on the bar 84 at a visual position on the bar 84 reflecting the temporal position of the segment 102 within the AV content as described herein. The indicator 86 reflects that in the present exemplary instance shown in FIG. 6, fast forwarding is being executed by virtue of the indicator 86 being presented as double right arrows. In addition and as may be appreciated from the (e.g. dialogue box) visual indication 104 that is shown (that may taper to a point 106 at or near the indicator 86 similar to the indications 88 and 96 as described above), a description of the audio video content derived from e.g. metadata associated with the audio video content may be presented audibly on the CE device and visually via the indication 104.

Note that this description need not necessarily be extracted from the AV content itself (though it may be in some embodiments e.g. using an AI module/software to generate a summary of and from audio and/or video of the AV content), but may be provided e.g. by the AV content provider as a description of what occurs at the segment 102 in e.g. summary form. Accordingly, since the information is described using audio and text that was not necessarily extracted from the AV content but may have been e.g. created as a summary of the segment by e.g. a third party, it may in exemplary embodiments be presented in parentheses to indicate it is a summary rather than a reflection of actual audio (e.g. a direct quote) from the AV content. In the present instance shown in FIG. 6, the audible and visual indications are understood to indicate that “Jake is going down first peak” to indicate in summary form what is occurring e.g. in the story line of the AV content at or around the segment 102. Also, note that the description may be a few words, an entire sentence, one or more sentences, or even an entire monologue spoken by a person in the AV content.

Even further and before describing FIG. 7, it is to be understood that any and/or all of the audible and textual/visual position information contained in the indications described herein may be combined, mixed, and matched. For instance, position information may be conveyed audibly and visually in both temporal parameters and also as summary information. As another example, position information may be audibly presented in summary form and/or as audio extracted from the AV content but only visually presented in temporal parameters such as minutes and seconds for the same segment.

Now in reference to FIG. 7, an exemplary settings UI 110 for a CE device is shown that includes at least one visually impaired setting that is configurable by a user of the CE device. The UI 110 may constitute its own, separate UI or may form a portion of a CE device settings UI that also includes settings options for non-visually impaired-related functions. Regardless, the exemplary UI 110 includes text 112 indicating that what is presented below the text 112 pertains to visually impaired settings for the CE device on which the settings UI 112 is presented.

At least a first setting 114 is shown on the UI 110 and pertains to presentation of an audible indication of position information in accordance with present principles during e.g. fast forwarding and rewinding of content (but may also pertain other content manipulations as well). The setting 114 therefore includes plural selectors 116 for selecting one and only one, or one or more, types of position information to present. In the present instance, the selectors 116 include at least one pertaining to temporal parameters (e.g. minutes and seconds), one pertaining to using extracted sound excerpts of audio of the AV content, and/or one pertaining to a description and/or summary of the position of the currently presented segment (e.g. that was created by the AV content provider as described herein). Also shown is a selector selectable to cause no audible indication whatsoever to be presented (reflected by the “nothing” text on the UI 110) during manipulation of the AV content.

A second setting 118 is also shown on the UI 110. The second setting pertains to whether a visual indication of position information in accordance with present principles should be presented (e.g. in addition to an audible indication). Plural selectors 120 are selectable to either input an affirmative or negative input to the CE device for whether to include such a visual indication. Last, note that the UI 110 includes a submit selector 122 selectable to save and/or submit the settings configured using the UI 110 for execution by the CE device's processor.

With no particular reference to any figure, it may now be appreciated that present principles provide methods, systems, and apparatuses for presenting at least audible indications of position information of a currently presented segment of AV content while e.g. normal content playback is being altered to thereby provide audible cues to a visually impaired user of the current position of the manipulated content to thus discern when to resume playback based on e.g. reaching a desired position within the AV content.

A user may thus be able to follow the progress of manipulated content as it is manipulated at a speed other than normal playback speed. This may be aided by providing audible and/or visual data in metadata accompanying AV content provided to and presented on the CE device that describes the content, and furthermore may be automatically presented to a user without further input from a user after e.g. the user configures visually impaired settings as set forth herein (e.g., which may be configured before a particular AV content file is even received by and/or presented on the CE device). Additionally, it is to be understood that the metadata in some embodiments may be embedded with the AV content itself so that the position information contained in the metadata cannot be stripped off or presented out of sync with the specific segment of AV content to which the metadata pertains as the AV content is transmitted through (e.g. arbitrary) AV content delivery systems.

Nonetheless, present principles further recognize that any of the foregoing indications may be presented during normal playback if desired as well (e.g., based on configuration to active of a setting on a settings UI pertaining to as much). It may also be appreciated that the foregoing provides methods, systems, and apparatuses for conveying position information to a user without employing an additional peripheral or handicap-adapted device to be used in conjunction with the CE device, and hence present principles reduce clutter, improve accessibility, and provide a simple and easy way of having position information provided.

Present principles further recognize that in some embodiments the audible and/or visual indications described herein may be presented only when at least one visually impaired setting such as those described above is set to active, though in other embodiments the audible and/or visual indications may be presented regardless of whether at least one visually impaired setting is set to active. Even further, present principles recognize that the foregoing may not only assist a visually impaired user but also a hearing impaired user e.g. by presenting position information visually as set forth above. Last, present principles recognize that although the foregoing detailed description was set forth in terms of AV content, audio only content and/or video only content may be presented on a CE device along with position information (either or both visual and/or audible) in accordance with present principles.

While the particular PROVIDING AUDIBLE INDICATION DURING CONTENT MANIPULATION is herein shown and described in detail, it is to be understood that the subject matter which is encompassed by the present invention is limited only by the claims.

What is claimed is:

1. An apparatus comprising:
at least one computer readable storage medium that is not a carrier wave and that is accessible to a processor, the computer readable storage medium bearing instructions which when executed by the processor cause the processor to:
present, on an audio video display device (AVDD), an audible indication of a position of a currently displayed video portion of audio video content within the audio video content.

2. The apparatus of claim 1, wherein the audible indication is derived from metadata associated with the audio video content.

3. The apparatus of claim 1, wherein the audible indication is expressed in temporal parameters related to the currently displayed video portion.

4. The apparatus of claim 3, wherein the temporal parameters include at least minutes and seconds.

5. The apparatus of claim 1, wherein the audible indication includes presenting a segment of audio from the audio video content.

6. The apparatus of claim 1, wherein the audible indication is a description of the audio video content derived from metadata of the audio video content.

7. The apparatus of claim 1, wherein the audible indication is presented at least in part in response to user manipulation of the audio video content that alters normal playback of the audio video content.

8. The apparatus of claim 7, wherein the user manipulation includes at least fast-forwarding or rewinding.

9. The apparatus of claim 1, wherein the computer readable storage medium bears further instructions which when executed by the processor cause the processor to:
present, on the AVDD, an visual indication of the position.

10. The apparatus of claim 9, wherein the visual indication is displayed in typography adapted for the visually impaired.

11. The apparatus of claim 1, wherein the audible indication is presented only when a visually impaired setting of the AVDD is set to active.

12. A method, comprising:
receiving, at a consumer electronics (CE) device, audio video (AV) content;
receiving, at the CE device, AV content position information associated with the temporal position within the AV content of at least one segment of video of the AV content;
presenting, on the CE device, at least the segment of video of the AV content; and
presenting, on the CE device at or around the time the segment of the AV content is presented, at least a portion of the AV content position information indicating the temporal position of the segment within the AV content.

13. The method of claim 12, wherein the portion is audibly presented.

14. The method of claim 12, wherein the portion is audibly and visually presented.

15. The method of claim 12, wherein the AV content position information is included in metadata received with the AV content.

16. The method of claim 12, wherein the portion of the AV content position information is presented only in response to user manipulation of the AV content that alters normal playback of the AV content.

17. The method of claim 12, wherein the AV content position information includes at least first and second portions of AV content position information respectively associated with first and second temporal positions within the AV content of segments of the AV content, and wherein the presenting of at least a portion of the AV content position information includes presenting the first portion at or around the time the first segment is presented and presenting the second portion at or around the time the second segment is presented.

18. A computer readable storage medium that is not a carrier wave, the computer readable storage medium bearing instructions which when executed by a processor configure the processor to execute logic comprising:
embedding AV content metadata associated with audio video (AV) content in an AV content file, the AV content metadata at least including temporal position information for at least one segment of the AV content;
providing the AV content file to at least one consumer electronics (CE) device.

19. The computer readable storage medium of claim 18, wherein the metadata is configured at least for audible presentation of the temporal position information of the segment on the CE device.

20. The computer readable storage medium of claim 18, wherein the temporal position information for the at least one segment includes at least one of the following: temporal data related to the segment configured for presentation on the CE device in minutes and seconds, and an audio description of the segment configured for presentation on the CE device wherein the audio description does not include any audio of the AV content.
